(19) United States
(12) Patent Application Publication
(10) Pub. No.: US 2001/0047552 A1
(43) Pub. Date: Dec. 6, 2001

(54) Slitter

(76) Inventor: Ronald H. Schimmel, Skokie, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/874,611

(22) Filed: Jun. 5, 2001

Related U.S. Application Data
(60) Provisional application No. 60/209,755, filed on Jun. 6, 2000.

(51) Int. Cl. B67B 7/00

(52) U.S. Cl. 7/156

(57) ABSTRACT

A slitter tool that has a generally flat body portion with a spaced elongated finger along one edge and a razor type blade held between the body and finger, includes a second spring like finger extending toward the blade to prevent side entry by a user's finger tip. A grooved end with the blade tip very slightly protruding permits opening of plastic wrapped CD packages or the like.

### CROSS-REFERENCE TO RELATED PATENT APPLICATIONS

This patent application claims the benefit of U.S. Provisional Patent Application No. 60/209,755, filed Jun. 6, 2000.

### FIELD OF THE INVENTION

The present invention relates generally to desk accessories and more particularly to slitters such as used for opening envelopes, clipping coupons or opening plastic or cellophane wrapped packs for CD's and the like.

### BACKGROUND OF THE INVENTION

Envelope closure openers or so-called “letter” openers having a razor type slitter incorporated in a flat body which is provided in a multitude of shapes or configurations to receive indicia as an advertising specialty item have been around for many years. Numerous patents have been issued for various designs and functional aspects of such devices and even more recently multi-functions have been given to the basic slitter to render it a combination tool.

Examples may been seen, i.e., in U.S. utility patents of Tilly U.S. Pat. No. 3,028,670; Carney et al. U.S. Pat. No. 5,285,577; and Vaught U.S. Pat. No. 5,720,062. On the design side, the following U.S. design patents illustrate how prolific and replete with variations the field has become to accommodate the demands for this type of device. See, for example, Goffe Des. No. 230,824; Schapiro Des. No. 333,773; Vaught Des. No. 388,306; Schmidt et al. Des. 353,316; Schmidt Des. No. 380,365; Koenig Des. No. 306,394; Lage et al. Des. No. 329,183; Des. No 342,008; Carney et al. Des. No. 350,770; Lage et al. Des. No. 355,108; Lage Des. 329,184; Wenk Des. 355,347; and Schmidt Des. No. 355,346.

For the most part, almost all of the forgoing prior art devices employ a generally flat body portion with a spaced elongated finger along one edge to enter an envelope sealed closure. A razor type blade is captively held near the distal end of the finger where it is joined to the body. Since the razor blade edge is not exposed and the slitting is confined in a gap between the finger and body, these types of slitters are generally safer than exposed blade or knife-edge devices. There are limits, however, to the size of the gap between the finger and body portion so that a user's finger or finger tip cannot be allowed to contact the blade.

### BRIEF SUMMARY OF THE INVENTION

Accordingly, it is a primary object of the present invention to provide a desk accessory slitter which overcomes the deficiencies in the prior art.

The present invention, in another of its primary objectives or goals, is to provide an improved slitter with a more guarded blade, yet which is still cheaply and easily manufactured in large numbers and readily lends itself to use in the advertising specialty field. It is another object to provide an improved safety slitter which can be incorporated in simple as well as combination type slitters which do provide a number of different and versatile functions to have a multi-purpose desk accessory.

In accordance with the objectives of the present invention, there is provided a second spring finger disposed between the first end finger and positioned in the gap and in close proximity to the edge of the blade so as to further guard the blade against accidental contact with a finger or finger tip of a user.

Other objects and advantages of the invention will become apparent from the following detailed description when taken in conjunction with the accompanying drawings.

### BRIEF DESCRIPTION OF THE DRAWINGS

FIG. 1 a perspective view of an exemplary embodiment of a combination or multi-function device embodying the present invention;

FIG. 2 is a right side plan view thereof;

FIG. 3 is a right side plan view thereof;

FIG. 4 is a rear plan view thereof;

FIG. 5 is a front plan view thereof;

FIG. 6 is a bottom plan view thereof; and

FIG. 7 is a top plan view thereof.

While the invention will be described with a specific embodiment, there is no intent to limit it to that embodiment. On the contrary, the intent is to cover all alternatives, modifications and equivalents as included within the spirit and scope of the invention.

### DETAILED DESCRIPTION OF THE INVENTION

Reference is made to Applicant's co-pending U.S. Design Application Ser. No. 29/117,471, filed Jan. 24, 2000 and entitled “Multi-Function Desk Accessory.” The device there shown is marketed currently by Applicant's assignee, Option Products, Inc., under the trademark Screen-A-Saurus™ and it includes a dust brush for PC screen cleaning as well as a staple remover or pop-top can opener, a letter or envelope slitter and CD plastic wrap opener among other handy uses including the best mode contemplated by the present inventor for carrying out his invention with respect to guarding of the slitter blade.

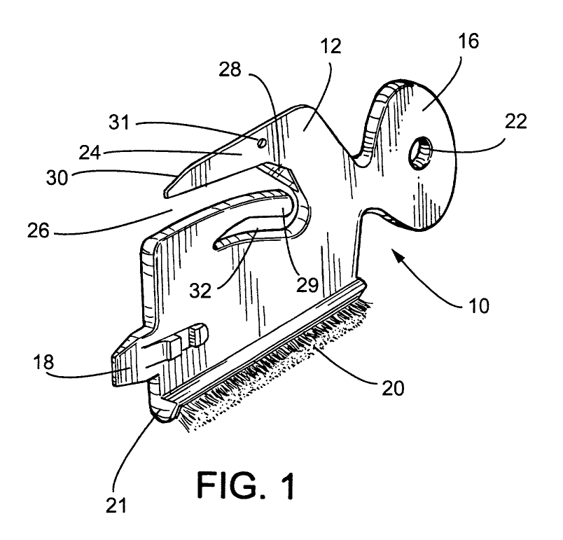

It will be appreciated, however, by those skilled in the art that the device can be widely varied as to shapes, types of material and fabrication methods. In its preferable form the device is molded out of plastic and is generally a flat, relatively thin cross-section body with an elongated finger member having a gap at its open free end running along one of the body sides. As best shown by reference to FIGS. 1-3, the unit body, generally indicated at 10, has front and back flat side walls 12,14, and includes a shaped handle portion 16 at one side and a wedge-shaped projection 18 at the opposite side. The projection 18 can serve as a staple remover or a pop-top can opener, or even a scratch off lottery ticket scraper. At the lower portion of side wall 12 as viewed in FIG. 1, a brush 20 is attached on a ramp like shelf 21 to provide a dust cleaner for PC screens or the like. The shelf 21 holds the brush 20 at about a 30° angle to the flat surface of the body for ease of use.

The handle portion 16 is provided with an opening 22 to receive a hanging hook (not shown).

In accordance with one of the features of the present invention an elongated finger portion 24 of the body 10 extends along one side end, here being opposite to the brush 20 side end and the finger 24 has one free end tapering to a somewhat arrowhead shape at its tip. A gap 26 extends between the finger 24 towards a captively mounted blade 28 with a razor-like edge facing the gap 26. This arrangement with the blade being angularly disposed allows the blade 28 to be used for slitting letters, opening envelopes or cutting coupons or the like from paper sheets.

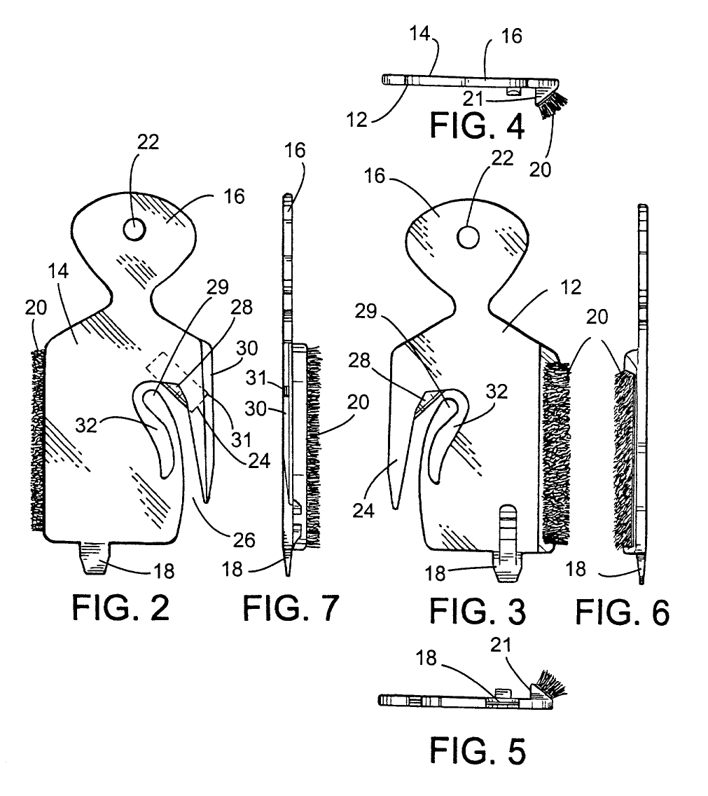

Referring to FIGS. 2 and 3, in accordance with the present invention, a second spring finger 29 is provided which serves to somewhat narrow or close the gap 26 adjacent to the blade 28 to guard against side entry of foreign objects or accidental finger tip cuts. The spring finger is cantilevered so as to enable some adjustment for card stock or multiple sheets, yet it does provide the additional safety measure in such devices. The spring finger is preferably disposed from the body 10 in a direction opposite to the extending direction of the finger 24, which due to the cut away relief 32 provides sufficient spring action but the finger 29 could be likewise running extending in the same direction as finger 24.

In accordance with yet another feature of the present invention, the outer edge of the finger 24 is provided with a grooved or rabbeted edge 30 along which a plastic or cellophane wrapped CD packet can be slid. The blade 28 has a tip 31 that very slightly protrudes into the grooved edge base so that it will cut thin plastic wraps.

It will be appreciated that the body 10 can be provided in many different forms or shapes and the flat side walls 12,14 do readily lend themselves to imprinting as an advertising specialty item.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A slitter tool comprising in combination:
a generally flat body portion having front and rear sides, top, bottom and end edges;
a spaced elongated first finger along one of said edges and ending in a free opening;
a razor-type blade positioned between the finger and body portion;
and a second spring-like finger on the body portion extending toward the blade and positioned in the space between the body and the first finger.

2. A slitter tool as claimed in claim 1 wherein the bottom edge is on the first finger;
a groove extends along said bottom edge; and
said blade having a tip that protrudes into the grove.

3. A slitter tool as claimed in claim 2 wherein said body includes multi-function elements along one or more of said other edges.

4. A slitter tool as claimed in claim 3 wherein one of said elements is a staple removal projection.

5. A slitter tool as claimed in claim 3 wherein one of said elements is a brush.

6. A slitter tool comprising in combination a generally flat body portion having front and rear sides, top, bottom and end edges;
a spaced elongated finger along one of said edges and ending in a free opening;
a razor-type blade positioned between the finger and body portion;
said finger having a groove at its outside edge; and
said blade having a tip that protrudes into the grove.
